(19) United States
(12) Patent Application Publication
(10) Pub. No.: US 2026/0127089 A1
(43) Pub. Date: May 7, 2026

(54) DYNAMIC RUNTIME BEHAVIOR MODIFICATION FOR SESSION-SPECIFIC LOGGING

(71) Applicant: SAP SE, Walldorf (DE)

(72) Inventor: Tom Spiegler, Langbrueck (DE)

(21) Appl. No.: 18/940,173

(22) Filed: Nov. 7, 2024

(51) Int. Cl. G06F 11/34

(52) U.S. Cl. CPC G06F 11/3476; G06F 2201/865

(57) ABSTRACT

Systems and methods described herein relate to runtime behavior modification for session-specific logging in the context of a software application. According to some examples, a system detects that session-specific logging is to be applied for a session of a software application. In response to detecting that session-specific logging is to be applied, the system enables the session-specific logging by dynamically adapting one or more original logging functions of the software application to provide one or more augmented logging functions. The software application is executed with the one or more augmented logging functions. As a result, session-specific logging is performed during the session to capture and store log data corresponding to a session-specific log level.

### TECHNICAL FIELD

The subject matter disclosed herein generally relates to logging in a software application context. More specifically, but not exclusively, the subject matter relates to the dynamic adaptation of logging functionality to selectively enable enhanced debugging or analysis capabilities.

### BACKGROUND

In a software application context, “logging” refers to a process of capturing information about an application's state, operations, issues, or events that occur during runtime. Software developers commonly use logging for purposes such as debugging, performance monitoring, or application behavior analysis. Log levels in software applications typically define the granularity or importance of information captured during logging. These levels can range from less severe (e.g., TRACE or DEBUG) to more severe (e.g., ERROR or FATAL), allowing developers to control the verbosity of log output and filter logs based on their type.

In various implementations, the log level is set globally, at a system-wide level. This global log level is often set at a relatively low level (e.g., a less verbose level, such as ERROR), which can result in technical challenges when it becomes necessary to debug specific issues or capture more detailed logs for particular features, sessions, or requests. For example, increasing the global log level for such purposes can cause excessive or complex log generation or degrade system performance.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment, according to some examples.

FIG. 2 is a block diagram of certain components of an application, according to some examples.

FIG. 3 is a flowchart illustrating operations of a method for implementing session-specific logging, according to some examples.

FIG. 4 is a swimlane flowchart illustrating operations performed by respective components of an application, wherein the application implements session-specific logging, according to some examples.

FIG. 5 is a table illustrating performance profile data for an application, wherein session-specific logging output is integrated into the performance profile data.

FIG. 6 is a block diagram showing a software architecture for a computing device, according to some examples.

FIG. 7 is a block diagram of a machine in the form of a computer system, according to some examples, within which instructions may be executed for causing the machine to perform any one or more of the methodologies discussed herein.

### DETAILED DESCRIPTION

When an issue arises within a software application, it may be possible to investigate and diagnose the issue directly on a user's computer system. However, diagnostic tools on the user's computer system may be limited when compared to what is available on a developer's computer system. It may also be undesirable to involve the user or their computer system in this process. Accordingly, it is often desirable for a developer to investigate or diagnose issues locally in a developer environment.

In some cases, a developer may replay a user's issue locally on the developer's computer system to investigate the root cause of the issue. However, this can be technically challenging, for example, due to the developer lacking privileges for certain operations, restrictions in transferring content from the user, or failures in transferring all relevant information to the developer environment. An alternative approach to this developer-user interaction is to generate server traces in sufficient detail to enable developers to investigate or diagnose issues. However, as mentioned, a log level associated with an application is often set globally. In other words, the application is unable to dynamically adjust the log level for individual server requests to provide a desired level of logging only for those individual requests.

The global log level is often set conservatively, such as at an ERROR level. This means that only messages that are flagged with ERROR, or an even more conservative log level, are captured. Changing the log level system-wide to a more detailed level (e.g., to a DEBUG level) may result in various technical challenges and may even require a system restart. These technical challenges can include excessive log generation (since a more fine-grained log level applies to all incoming requests), overloading a log database, or complicating the logs that are of interest. When too many log entries are being generated, older logs may be removed due to log rotation or log size limitations. Furthermore, this system-wide increase in log generation can degrade system performance (e.g., because of the increase in computing resources needed to process and write log data).

Examples in the present disclosure enable dynamic, granular log level changes without affecting a global log level of a software application. In some examples, when an application (e.g., backend-based application) receives a flag to run a specific request at an increased log level, the application automatically (at runtime) replaces an original logger's functions (e.g., methods) with one or more augmented logging functions (e.g., methods) that capture log data. In this way, the application can implement session-specific logging regardless of the log level associated with the original logger (e.g., the global log level). In some examples, the behavior of the original logger is maintained while running enhanced logging to avoid interference with default logging that is applied across various requests or processes of the application.

A “log level,” as used herein, may refer to one of a set of categories used to classify the importance, severity, type, or detail of log messages generated by a software application. For example, a hierarchical set of log levels, in order of increasing detail or verbosity, might include:
1. FATAL: Represents severe error conditions that may lead to application failure.
2. ERROR: Signifies error conditions that may require attention but do not halt the application.
3. WARN: Indicates potential issues or unexpected events that do not prevent normal operation.
4. INFO: General information about the application's operation.
5. DEBUG: Detailed information useful for debugging purposes.
6. TRACE: The most granular level, used for highly detailed debugging information.

In the above set of log levels, TRACE would provide the largest volume of log data when compared to the other log levels. For example, setting the log level to TRACE would capture all log data (e.g., messages) irrespective of the log level linked to the log data. As another example, setting the log level to INFO would capture all log data at INFO level and below (WARN, ERROR, and FATAL), while excluding DEBUG and TRACE data. As a further example, setting the log level to ERROR would capture only log data at ERROR level and FATAL level, while excluding all other levels. It is noted that the above hierarchy is a non-limiting example that is intended to illustrate certain principles, and that various other sets or hierarchies of log levels may be used with examples in the present disclosure. For example, a hierarchy may be implemented in the reverse order, starting at TRACE (position 1) and ending in FATAL (position 6). Accordingly, depending on the way in which a hierarchy is defined, a message may be logged if its log level is equal to or greater than the logging component's log level setting, or equal or lower than the logging component's log level setting.

The term “default logging,” as used herein, may include a default or standard logging mechanism employed by an application or system to capture log data corresponding to a global log level. Default logging may be performed application-wide or system-wide, unless specifically disabled. A “global log level,” as used herein, may include a global logging severity threshold that is applied, by default, across sessions, requests, components, or modules of an application or system. For instance, in a production environment, default logging might be set to capture at an ERROR level (as an example of a global log level) to minimize performance impact and storage requirements, while ensuring that some level of useful information is recorded.

The term “session-specific logging,” as used herein, may include a targeted logging mechanism that captures log data for a specific session or request within a software application. For example, session-specific logging is applied only when a request, parameter, or flag indicates that it should be enabled, and does not affect other requests or a global logging configuration. In this context, a “session” may include a discrete process, request, or period of interaction that is handled by an application or system. For example, session-specific logging might be applied to a single request-response cycle or to a series or related operations associated with a request. A “session-specific log level,” as used herein, may include a designated logging severity threshold that is applied selectively to a particular session or request.

The session-specific log level can be dynamically set and may differ from the global log level. This allows, for example, for more detailed logging on a per-session or per-request basis without significantly affecting the entire system.

An example method includes detecting that session-specific logging is to be applied for a session of a software application, and enabling session-specific logging in response to the detection. In some examples, session-specific logging is enabled for the handling of a specific request, such as a request received from a client (e.g., a web client) at a server (e.g., a server running a backend software application).

Session-specific logging may be enabled by dynamically adapting one or more original logging functions of the software application to provide one or more augmented logging functions. The software application is executed with the one or more augmented logging functions, thereby performing session-specific logging to capture log data corresponding to a session-specific log level during the session.

In this context, log data “corresponding to” the session-specific log level includes log data that at least meets a threshold associated with the session-specific log level. For example, when using the example hierarchy discussed above, if the session-specific log level is DEBUG, log data corresponding to the session-specific log level includes incoming log data associated with any of the following log levels: DEBUG, INFO, WARN, ERROR, and FATAL.

In some examples, the one or more augmented logging functions add the session-specific logging to default logging associated with the one or more original logging functions. Accordingly, the executing of the software application with the one or more augmented logging functions may include performing the default logging at a global log level (e.g., ERROR level) associated with the one or more original logging functions in addition to performing the session-specific logging at the session-specific log level (e.g., DEBUG level). In some examples, the session-specific log level is thus an increased log level relative to the global log level. In this context, an “increased” log level refers to a more detailed or verbose log level, such as a log level that appears lower down on the aforementioned example hierarchy.

In some examples, dynamic adaptation of the one or more original logging functions comprises dynamically replacing the one or more original logging functions with the one or more augmented logging functions at runtime. The augmented logging functions may maintain behavior of the one or more original logging functions and add additional behavior to enable the session-specific logging.

A system of the present disclosure may instantiate, at runtime, a session-specific logging component (e.g., object) to provide the one or more augmented logging functions and to receive logging calls to capture the relevant log data. In some examples, a new logger instance is generated for each session-specific logging process. A logging call may include an invocation of a logging function within the software application to record specific information. Logging calls may be made at various points in the application code to capture relevant data, events, or the state of the application for debugging, monitoring, or auditing purposes. These calls may be directed to different logging levels. In some examples, the session-specific logging component interprets logging calls directed to an original logging component (e.g., object). For example, when session-specific logging is enabled, a Logger.debug(“message”) call may be intercepted by an augmented logging function that captures the message for session-specific logging before, or instead of, invoking the original logging function.

In some examples, the method includes automatically integrating the log data with performance profile data of the software application. Performance profile data may include detailed information about the execution characteristics of a software application. The performance profile data may encompass various information or metrics such as an execution hierarchy, function execution times, call frequencies, memory usage, or resource utilization patterns. In the context of the present disclosure, performance profile data may be integrated with log data to provide a more comprehensive view of the application's behavior during a specific session or in the handling of a specific request. For instance, the system automatically integrates log data with performance profile data to provide a hierarchical view that reflects an execution stack of the software application, allowing developers to correlate logged events with performance metrics for more effective debugging or optimization.

Techniques described in the present disclosure improve the functioning of a computer system by enabling dynamic, fine-grained logging control without modifying an existing codebase or significantly impacting system-wide performance. In some examples, by dynamically adapting logging functions at runtime, the system allows for session-specific logging at increased verbosity levels while maintaining a global log level.

Examples described herein solve technical problems such as the prevention of unnecessary log generation and the preservation of system resources, while enabling more efficient and effective debugging and issue resolution. For example, a system as described herein allows for session-specific logging to capture log data corresponding to a session-specific log level during a session, without requiring system-wide log level changes or restarts.

Session-specific logging can easily be applied to one or more specific requests or features that are of interest (e.g., to users or developers). Additionally, techniques in the present disclosure allow for separate storage of session-specific logs, facilitating compliance with data protection regulations and improving log management, without impacting default log storage configurations. For instance, the system executes the software application with the one or more augmented logging functions, performing session-specific logging to capture, at a first storage location, log data corresponding to a session-specific log level during the session. Substantially simultaneously, the system separately performs default logging to capture log data corresponding to a global log level at a second storage location. This approach allows for detailed and separate logging only for specific sessions or requests, while maintaining default logging for the rest of the system.

Furthermore, integration with performance profiling may further enhance the system's ability to provide context-rich, hierarchical views of log data, improving the efficiency of troubleshooting and system analysis. As an example, call stack tracking and logs can be combined. Logs are usually stored in a simple or primitive format, such as a text file. A performance profiler can be used to present a call stack in a hierarchical fashion, including log statements related to the call stack. The profiler may include log statements within the context of the call stack. This allows for easier understanding of the application's control flow while also allowing developers more easily to identify, for example, the code that invoked a logging call.

Examples described in the present disclosure provide a practical application that is specifically tied to computing technology. For example, the present disclosure provides a practical application for improving the usefulness and efficiency of session backend tracing through dynamic changes in log levels.

When the effects in this disclosure are considered in aggregate, one or more of the methodologies described herein may obviate a need for certain efforts or resources that otherwise would be involved in logging, debugging, or related operations in a software system context. Computing resources utilized by systems, databases, or networks may be more efficiently utilized or reduced, e.g., as a result of enabling dynamic, fine-grained logging control without causing unnecessary log generation or storage. Examples of such computing resources may include processor cycles, network traffic, memory usage, graphics processing unit (GPU) resources, data storage capacity, power consumption, or cooling capacity.

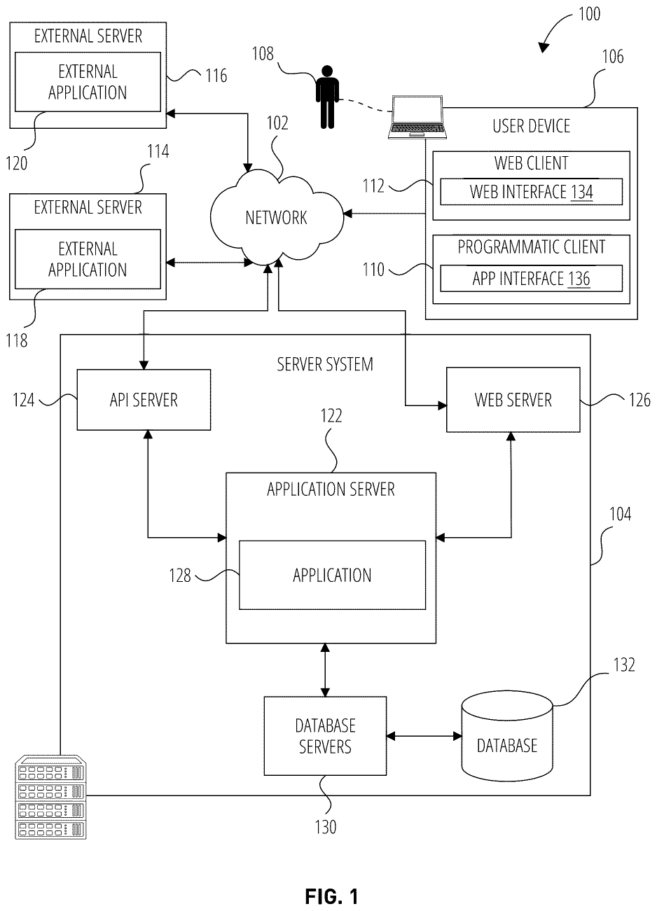

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 112 (e.g., a browser) or a programmatic client 110 (e.g., an “app”) may be hosted and executed on the user device 106.

An Application Program Interface (API) server 124 and a web server 126 provide respective programmatic and web interfaces to components of the server system 104. An application server 122 hosts an application 128, which may include various components or modules.

The user device 106 can communicate with the application server 122 via, for example, the web interface supported by the web server 126 or the programmatic interface provided by the API server 124. It will be appreciated that, although only a single user device 106 is shown in FIG. 1, a plurality of user devices may be communicatively coupled to the server system 104 in some examples. Further, while certain functions (e.g., functions of the application 128) may be described herein as being performed at either the user device 106 (e.g., web client 112 or programmatic client 110) or the server system 104, the location of certain functionality either within the user device 106 or the server system 104 may be a design choice.

The application server 122 is communicatively coupled to database servers 130, facilitating access to one or more information storage repositories, such as a database 132. In some examples, the database 132 includes storage devices that store information to be processed by the application 128.

The application server 122 accesses application data (e.g., application data stored by the database servers 130) to provide the application 128 to the user device 106 via a web interface 134 or an app interface 136. The application 128 in FIG. 1 may include a software program or set of programs that run at least partially on the application server 122 within the server system 104. In some examples, the application 128 provides data processing functionality that enables the user 108 to have complex calculations, data manipulations, or data transformations automatically performed on the server side. Examples of core functionality of the application 128 can include:
Data retrieval: Fetching datasets from the database 132 based on user-specified parameters.
Data transformation: Applying complex algorithms or models to process and transform the retrieved data.
Data analysis: Performing statistical analyses, pattern recognition, or other analytical operations on the data.
Simulation and modeling: Running simulations or predictive models based on the input data and parameters.
Data visualization: Generating visual representations of processed data or analysis results.

In some examples, these data actions are initiated when the user 108 uses the user device 106 to interact with a front-end interface (e.g., web interface 134 or app interface 136) and sends a request to the application server 122. The application 128 executes the data actions and returns results or output back to the user 108 via the user device 106 (e.g., via the same front-end interface).

The application 128 incorporates logging functionality. For example, during execution of the application 128, log data are captured and stored in the database 132 for subsequent analysis (e.g., for debugging purposes). In some examples, the application 128 incorporates session-specific logging functionality as described in the present disclosure. This enables the application 128 to dynamically adapt its logging behavior based on specific session requirements without modifying its core functionality.

In some examples, when the application 128 receives a request indicating that session-specific logging is to be applied, it may detect this requirement and enable the session-specific logging functionality. This process may involve dynamically adapting one or more original logging functions of the application to provide one or more augmented logging functions. The application 128 may execute with these augmented logging functions, performing session-specific logging to capture log data corresponding to a session-specific log level during the session. Simultaneously, the application 128 may continue to perform default logging at a global log level, allowing for the coexistence of both logging approaches.

Log data can be stored in databases, files, or other storage systems. Log data can also be included in results or output data returned to the user device 106. In some examples, the application 128 stores the log data from the session-specific logging at a separate storage location, distinct from the default storage location used for system-wide logging (e.g., in a separate database or in a separate part of the database 132). This separation allows for more granular control over sensitive log data and may facilitate compliance with data protection regulations without affecting the entire system's logging behavior.

In some examples, the application server 122 is part of a cloud-based platform provided by a software provider that allows the user 108 to utilize various tools, features, or applications (e.g., the application 128 and one or more other applications). For example, the user 108 is an account holder who accesses one or more cloud instances managed by the software provider. The user 108 can access the cloud instances using suitable login credentials to leverage these tools, features, or applications.

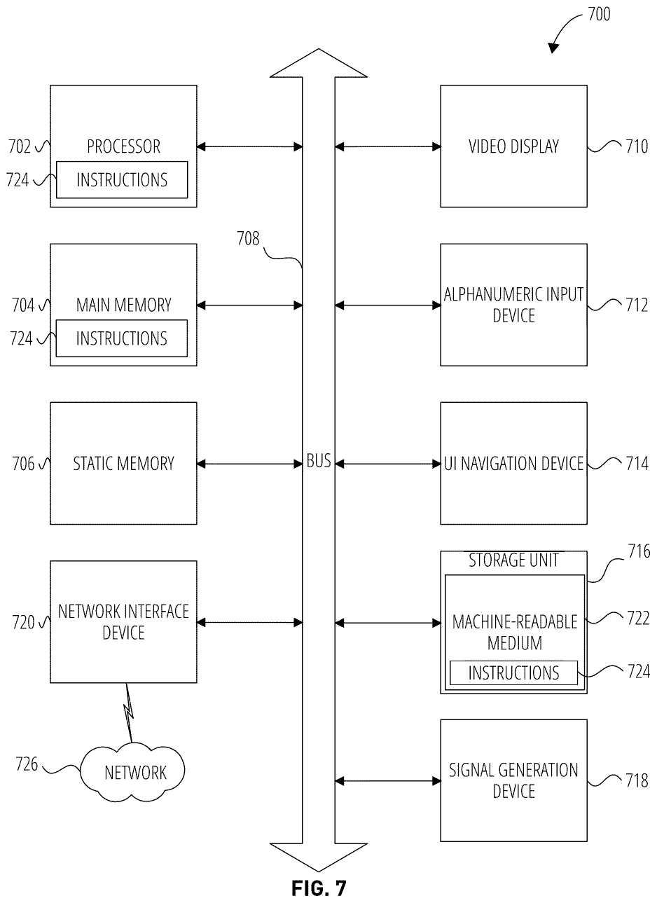

One or more of the application server 122, the database servers 130, the API server 124, or the web server 126, may each be implemented in a computer system, in whole or in part, as described below with respect to FIG. 7. In some examples, external applications (which may be third-party applications or applications provided by the software provider referred to above), such as an external application 118 executing on an external server 114 and an external application 120 executing on an external server 116, can communicate with the application server 122 via the programmatic interface provided by the API server 124. For example, a third-party application may support one or more features or functions on a website or platform hosted by a third party, or may perform certain methodologies and provide input or output information to the application server 122 for further processing or publication.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

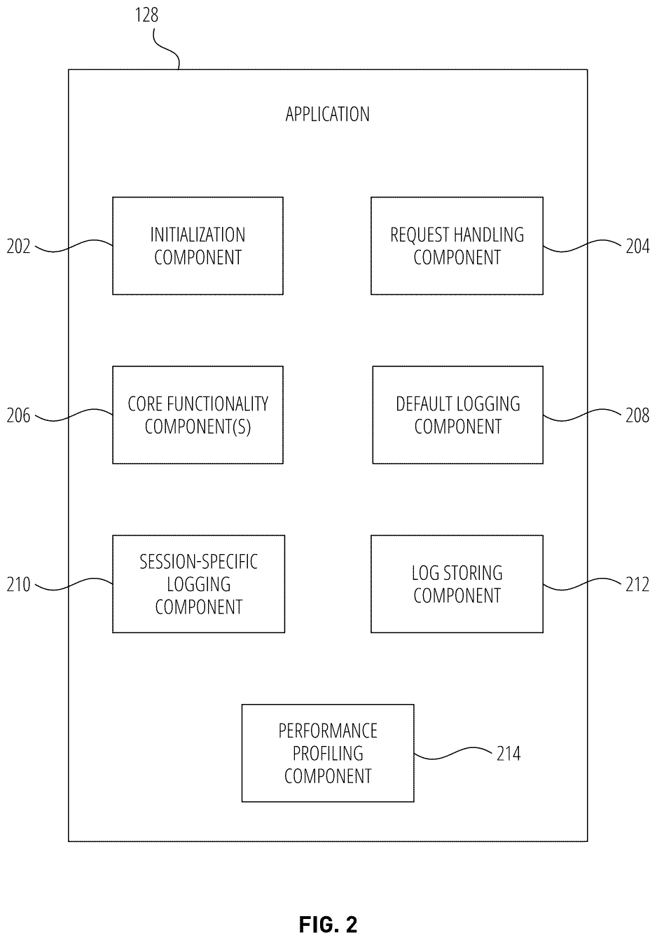

FIG. 2 illustrates components of the application 128 of FIG. 1, according to some examples. The application 128 is shown to include an initialization component 202, a request handling component 204, core functionality component(s) 206, a default logging component 208, a session-specific logging component 210, a log storing component 212, and a performance profiling component 214.

The initialization component 202 is responsible for setting up the application 128 and its functionality, including, for example, core functionality and logging. From a logging perspective, in some examples, the initialization component 202 initializes a default logging configuration and prepares the application 128 for potential session-specific logging.

The request handling component 204 is configured to process incoming requests to the application 128. In some examples, the request handling component 204 checks incoming requests (e.g., from the user device 106) and triggers the relevant application functionality provided by the core functionality component(s) 206. In some examples, the request handling component 204 analyzes request parameters to determine whether session-specific logging is required for a particular session. For instance, the request handling component 204 checks for the presence of a flag or parameter in the incoming request that indicates the need for enhanced logging.

In other examples, the flag or parameter is found elsewhere, such as in settings stored in the database 132 for a particular request. In such examples, the incoming request thus need not necessarily indicate that session-specific logging is needed or requested. For instance, the settings stored in the database 132 might include a user-specific flag that enables the application 128 to match an incoming request (that identifies the relevant user) with the user-specific flag, thereby triggering session-specific logging.

The core functionality component(s) 206 includes one or more components responsible for executing primary operations, functionality, or business logic of the application 128. For example, in response to a request, the core functionality component(s) 206 executes main tasks and processes that define the purpose and functionality of the application 128. As mentioned above, this could include, for example, data retrieval, transformation, analysis, simulation, or visualization. However, it is noted that techniques described herein can be implemented in various types of applications and these functions are merely examples.

In some examples, the core functionality component(s) 206 interacts with other components, such as the default logging component 208, the session-specific logging component 210, or the log storing component 212, to record relevant information during execution. The core functionality component(s) 206 may include functions that make logging calls, which can be processed by the default logging component 208 or by the session-specific logging component 210.

The default logging component 208 provides a standard logging mechanism of the application 128. In some examples, the default logging component 208 operates at a global log level. In some examples, the default logging component 208 is responsible for capturing log data corresponding to the global log level (e.g., meeting at least the threshold of the global log level) for all sessions. In some examples, the default logging component 208 continues to function alongside session-specific logging when the latter is enabled for a particular session, ensuring that system-wide logging is maintained even when enhanced logging is activated. The default logging component 208 may communicate with the log storing component 212 to ensure that log data is stored (e.g., in the database 132).

The session-specific logging component 210 provides enhanced logging functionality for specific sessions. In some examples, the session-specific logging component 210 is dynamically instantiated when session-specific logging is required. In some examples, the session-specific logging component 210 augments the original logging functions of the application 128 to provide one or more augmented logging functions. These augmented functions may capture log data corresponding to a session-specific log level, which can be more detailed than the global log level.

The session-specific logging component 210 may communicate with the log storing component 212 to ensure that log data is stored (e.g., in the database 132). In some examples, the log storing component 212 stores the captured log data from a session-specific logging process in a separate storage location, distinct from the default logging storage.

The performance profiling component 214 of the application 128 is configured to provide profiling capabilities. Various techniques can be used to enable the application 128 to generate performance profile data.

In some examples, the performance profiling component 214 automatically extends profiling capabilities to the application 128 without requiring changes to the existing code base. The performance profiling component 214 may operate by injecting profiling code into application modules when they are loaded at runtime, allowing for comprehensive performance monitoring across the application 128. For example, the performance profiling component 214 provides a mechanism that replaces a module import and replaces original exported methods and classes with functions that additionally track function runtimes (e.g., maintaining the original functionality while also tracking additional information, such as function runtimes). The performance profiling component 214 can capture detailed timing information for function calls and present this data in a hierarchical fashion, reflecting the application's call stack.

Additionally, the performance profiling component 214 can integrate performance profiling with logging, such as the session-specific logging functionality, to provide a unified view of both performance metrics and log data within the context of the application's execution stack. In this context, it is noted that logs are often written to primitive text files. Such log output is thus not usually hierarchical. As a result, developers or a logging framework may need to print sufficient information in the logs to be able to find the context in which a log line was generated. This may result in significant time being consumed to investigate issues, for example, because log entries do not contain sufficient context information or duplicate lines are printed (and it is unclear why they were printed). In some examples, the performance profiling component 214 is configured to integrate log data generated, for example, from the session-specific logging component 210 into performance profile data to address or alleviate these issues. In the context of performance profiling, calls to the logging component may be handled similar to other profiled function calls. The performance profiler may, however, also specifically track the log message, allowing it to be displayed directly in the hierarchy view of the call stack.

The session-specific logging component 210 can enable session-specific logging through dynamic method replacement. Pseudocode illustrating exemplary aspects of session-based logging with dynamic method replacement, which may utilize one or more of the components of FIG. 2, is included below. The pseudocode demonstrates a SessionLogger class that captures logging calls, augments original logging functions to enable session-specific logging, and allows for dynamic log level adjustment on a per-session basis.

```
// A class that allows capturing logging calls
class SessionLogger {
    logLevel: LogLevel;
  constructor(sessionLogLevel) {
      // specifies log level at which logs should be
captured
      this.logLevel = sessionLogLevel;
    }
    capture(logLevel, message) {
      // recording the log entry if log level is
sufficient
      if (logLevel <= this.logLevel) {
        // ...
      }
    }
    augmentLogging( ) {
      Logger = import(“Logger”);
      sessionLogger = this;
      // overwrite logging functions to capture calls
      debug = Logger.debug;
      Logger.debug = function logDebug(message) {
        // capture debug log call
        sessionLogger.capture(LogLevel.DEBUG, message);
        // call original logger
        return debug.call(this, message);
      }
      //... analogous for error, warn, info and/or other
log levels
      }
}
// --------------------------------------
// run program with session-based logging if requested
function main( ) {
  if (enableSessionLogging) {
    sessionLogger = new SessionLogger(LogLevel.INFO);
  }
  // ... program ...
}
```

In the above pseudocode, the SessionLogger class contains a logLevel property, which corresponds to the session-specific log level of the session-specific logging component 210 that determines the granularity, verbosity, or type of log data to be captured. The constructor of the SessionLogger class initializes the logLevel property, allowing the specification of the session-specific log level when a new instance is created.

The capture method within the SessionLogger class is responsible for recording log entries if the provided log level corresponds to the session log level. The augmentLogging method represents the dynamic adaptation of logging functions. This method overwrites the original logging functions (such as debug) of the original logger (Logger) with augmented versions that first capture the log message using the SessionLogger instance, then call the original logger. This implementation allows for the coexistence of session-specific logging and default logging, as represented by the session-specific logging component 210 and the default logging component 208 in FIG. 2.

Accordingly, in some examples, the application 128 has a plurality of original logging functions, each associated with a logging call for a respective log level (e.g., DEBUG, ERROR, WARN, and INFO), and the augmentLogging method causes replacement of each of the plurality of original logging functions in the manner described herein. Still referring to the pseudocode example, the main function demonstrates how the SessionLogger is instantiated and integrated into the application flow. The application 128 checks for an enableSessionLogging flag, which may, for example, be present in an incoming request. If enabled, a new SessionLogger instance is created with a specified log level (which is INFO in the example provided).

At runtime, the SessionLogger captures or intercepts all method calls to the original logger of the application 128, and may collect or persist the log output to a specified destination, such as a database table, a specific file, or response payload. Thus, the SessionLogger may, independently from the original logger, implement a dynamic log level change that can be enabled for a specific session or request. The SessionLogger may also independently comply (or provide enhanced compliance) with certain data storage or privacy requirements since it may store its logs in a different storage location than those of the original logger.

It is noted that, in at least some examples, session-specific logging as described in the present disclosure is implemented in a JavaScript environment, such as NodeJS or XSJS (the latter being used, for example, in the SAP HANA™ environment). Technical benefits associated with such an environment may include code interpretation at runtime (e.g., no compiled code or bytecode), and the dynamic nature of JavaScript facilitating runtime adjustments.

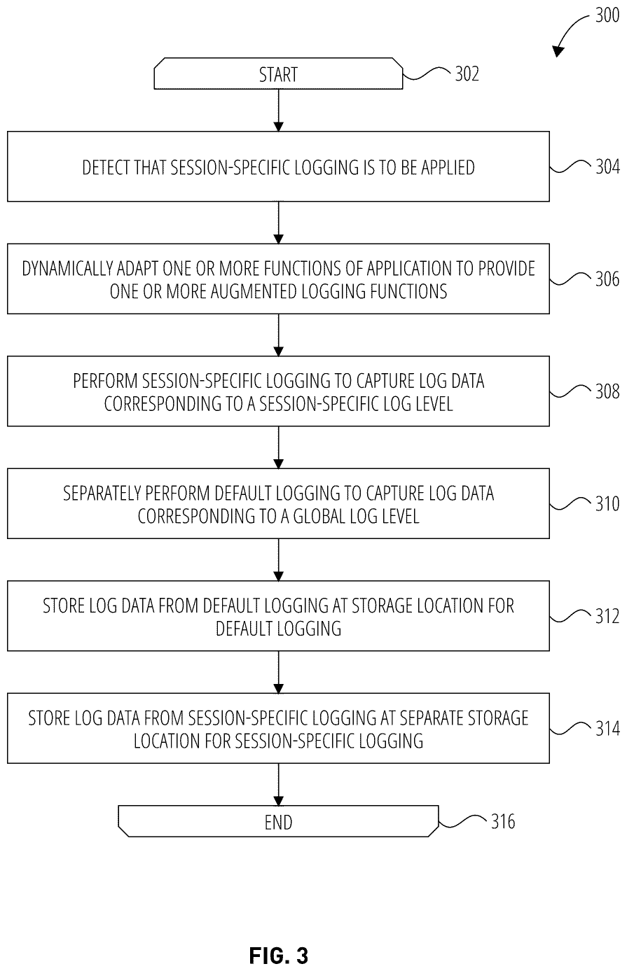

FIG. 3 illustrates a method 300 for implementing session-specific logging, according to some examples. By way of example and not limitation, aspects of the method 300 may be performed by the components, devices, systems, network, or databases shown in FIG. 1 and FIG. 2.

The method 300 commences at opening loop operation 302 and proceeds to operation 304, where the application 128 detects that session-specific logging is to be applied. For example, the request handling component 204 of the application 128 detects a parameter (e.g., a session-specific logging flag) in an incoming request from the web client 112 running on the user device 106, indicating that session-specific logging is to be applied. Session-specific logging may thus be implemented in a granular manner, such as based on an individual request.

At operation 306, the application 128 (e.g., the session-specific logging component 210) dynamically adapts one or more functions of the application 128 to provide one or more augmented logging functions. For example, the augmentLogging method as discussed above is utilized to obtain the augmented logging functionality through dynamic method replacement at runtime. In some examples, the session-specific logging component 210 operates to inject the logging code (e.g, adapted or augmented logging functions) dynamically as modules are loaded, without requiring changes to the original codebase.

Then, the application 128 performs session-specific logging (e.g., using the session-specific logging component 210) to capture log data corresponding to a session-specific log level at operation 308. The session-specific log level can be predetermined (e.g., stored in the database 132) or specifically identified for the relevant session (e.g., included in the incoming request). The session-specific log level can be an increased log level relative to the global log level of the application 128 (e.g., DEBUG, where the global log level is set at ERROR).

In some examples, and as shown at operation 310 of the method 300, the application 128 also performs default logging (e.g., using the default logging component 208) to capture log data corresponding to the global log level. In this way, the augmentation of the logging functionality of the application 128 with respect to the specific session does not impact the regular logging that is performed across all sessions or requests.

At operation 312, the application 128 stores log data from the default logging process at a first storage location, and at operation 314, the application 128 stores log data from the session-specific logging process at a separate storage location. The method 300 concludes at closing loop operation 316.

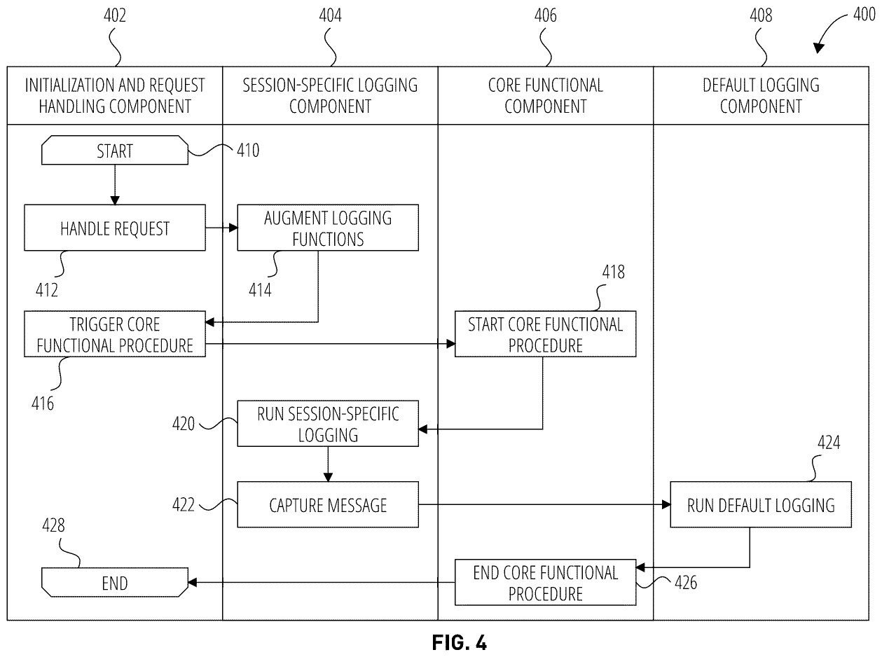

FIG. 4 illustrates a method 400 for implementing session-specific logging, according to some examples. By way of example and not limitation, aspects of the method 400 are performed by an initialization and request handling component 402, a session-specific logging component 404, a core functional component 406, and a default logging component 408, respectively, as shown in FIG. 4.

The components in FIG. 4 can, for example, be similar to the components of the application 128 of FIG. 1 and FIG. 2. The initialization and request handling component 402 may provide functionality similar to that of the initialization component 202 and the request handling component 204 described with reference to FIG. 2. The core functional component 406 may be one of the core functionality component(s) 206 of FIG. 2. The session-specific logging component 404 and default logging component 408 may be similar to the session-specific logging component 210 and the default logging component 208 of FIG. 2, respectively.

A code snippet is shown below to further illustrate aspects related to the flowchart of FIG. 4. Names and identifiers in the code snippet correspond to the above pseudocode related to the SessionLogger class. In the context of FIG. 4, the main function in the code snippet corresponds to an example of the initialization and request handling component 402, the SessionLogger corresponds to an example of the session-specific logging component 404, the Foo class corresponds to an example of the core functional component 406, and Logger corresponds to an example of the default logging component 408 (e.g., an original logger that operates at the global log level of the application 128).

```
main( ) {
  SessionLogger = import(“SessionLogger”);
  sessionLogger = new SessionLogger(LogLevel.DEBUG);
  sessionLogger.augmentLogging( );
  Foo = import(“Foo”);
  Foo.bar( );
}
class Foo {
  bar( ) {
    Logger = import(“Logger”);
    Logger.debug(“bar entered”);
  }
}
```

Referring now to the operations depicted in FIG. 4, the method 400 starts at opening loop operation 410. For example, the initialization and request handling component 402 receives an incoming request that was received by the application 128 (e.g., from the user device 106) and determines that session-specific logging is to be applied.

The request may be a request to perform one of the core functions of the application 128. For example, the request is a data modification request received from the user device 106. The request can include parameters to be processed in a data modification workflow and can also include a flag indicative of the instruction to apply session-specific logging.

The method 400 proceeds to operation 412, where the initialization and request handling component 402 handles the logging aspects of the request by instantiating the session-specific logging component 404. For example, and as shown in the above code snippet, a new SessionLogger object is created with a specified log level (in this case, DEBUG).

At operation 414, the session-specific logging component 404 augments the original logging functions of the application 128. In other words, the session-specific logging component 404 dynamically injects augmented logging functions to enable the session-specific logging for the session. For example, and as shown in the above code snippet and pseudocode, method replacement is performed via the augmentLogging method to import an original logger (e.g., the default logging component 408) and overwrite its original logging functions (e.g., debug, error, warn, and the like) with new functions that include additional functionality.

Once augmented logging is enabled, the initialization and request handling component 402 triggers a core functional procedure of the application 128 at operation 416. For example, the data modification workflow is triggered based on the parameters in the initial request. The core functional component 406 of the application 128 starts the core functional procedure at operation 418. For example, and as shown in the above code snippet, the Foo module is imported and its bar method is called. This method imports the original logger and includes a logging call.

As shown at operation 420, the session-specific logging component 404 performs operation 420 by intercepting the logging call. In other words, as a result of the augmentation, the augmented logging functions of the session-specific logging component 404 receive and handle the logging call directed to the original logger.

At operation 422, the session-specific logging component 404 captures a message from the logging call. For example, the session-specific logging component 404 checks whether the log level of the message meets the threshold specified by the session-specific log level and, if so, it causes the message to be recorded.

As an example, and as shown in the above code snippet, the Foo.bar method calls Logger.debug(“bar entered”). This calls the dynamically augmented debug method (instead of the original one) and the SessionLogger captures the “bar entered” message as log data. The message can be stored in a database table or other storage location. In some examples, the message is stored in a dedicated, separate storage location for session-specific logging.

The method 400 proceeds to operation 424, where the default logging component 408 runs default logging. As shown in the above pseudocode, the original logging functions may be augmented such that the application 128 not only performs session-specific logging, but also triggers the original logging process of the application 128.

Thus, in addition to the logging performed at the session-specific log level by the session-specific logging component 404, the default logging component 408 processes the logging call at the global log level of the application 128. Depending on the global log level, the default logging component 408 may or may not capture the relevant message as log data. For example, if the global log level is set at ERROR, the message “bar entered” with the DEBUG level specified would not be captured and stored by the default logging component 408.

It should be appreciated that various logging calls can go through the session-specific logging component 404 during processing of the request of operation 412, and these logging calls can have varying log levels. Such calls are intercepted by the session-specific logging component 404 and processed at the session-specific logging before they are passed to the default logging component 408 for processing. Multiple messages can thus be captured and stored for a single request, and they may be stored at different storage locations, corresponding to the session-specific logging component 404 and the default logging component 408, respectively. At operation 426, the core function procedure is ended by the core functional component 406, and the method 400 concludes at closing loop operation 428.

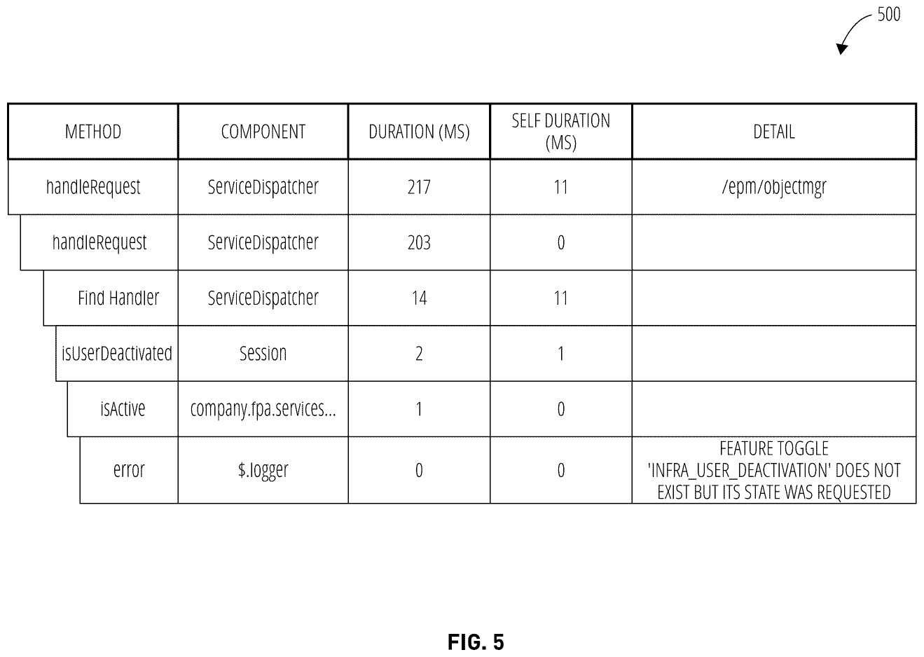

FIG. 5 shows a table 500 with performance profile data for an application, such as the application 128 of FIG. 1 and FIG. 2, where logging output (e.g., session-specific logging output) is integrated into the performance profile data. As discussed, techniques described in the present disclosure can be implemented alongside performance profiling.

The table 500 shows performance profile data generated by a performance profiler, such as the performance profiling component 214 of FIG. 2. The performance profiler automatically tracks function runtimes and call stacks.

The performance profiler can utilize techniques similar to those described with reference to the session-specific logging components (e.g., the session-specific logging component 210 and the session-specific logging component 404) to dynamically inject profiling code into modules when they are loaded. For example, at runtime, the application 128 may operate to replace the module import process and replace original exported methods and classes with new functions that maintain the original functionality, while also tracking additional information such as function runtimes. In some examples, the performance profiler injects the profiling code dynamically as modules are loaded, without requiring changes to the original codebase.

In some examples, with the integration of logging functions as described in the present disclosure, the performance profiler does not distinguish between regular application functions and injected logging functions. This may be a result of a dynamic process of function (e.g., method) adaptation, for example, as described with reference to FIG. 4. In other examples, the session-logging component may be exempt from dynamic performance profiling. The session-logging component may specifically add performance profiler entries in its injected “capture” method (for example, as described in [0058]). This allows for a log message that is supposed to be logged to be additionally tracked and thus stored in the relevant performance profile.

The performance profiler is aware of the callee of a relevant function. As a result, it is possible to present capture log data in the context of a call stack. The hierarchical structure of the table 500 reflects the call stack, as indicated by the indented nature of the “METHOD” column entries. For example, the “handleRequest” method is a top-level method, which contains nested calls to other methods.

In the table 500, the “METHOD” column shows the different functions or methods being called. The “COMPONENT” column indicates which component or class the method belongs to. The “DURATION” column shows the total time spent in each method, including time spent in its callees, while the “SELF DURATION” column represents the time spent in the method itself, excluding time spent in its callees. From a log data perspective, it is noted that in the example of FIG. 5, an error message (as captured using a logger) in the final entry of the table 500 is integrated into the performance profile data and shown fully in the “DETAIL” column.

Integration of logging with performance profile data may thus provide a more comprehensive view of the application's behavior. Developers can more easily pinpoint the code that triggered a logging call, as it appears in the context of surrounding calls. In some examples, this functionality is achieved without requiring changes to the original application code, as the application 128 leverages, for example, dynamic method replacement techniques for both performance profiling and session-specific logging.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: detecting that session-specific logging is to be applied for a session of a software application; in response to detecting that the session-specific logging is to be applied, enabling the session-specific logging by dynamically adapting one or more original logging functions of the software application to provide one or more augmented logging functions; executing the software application with the one or more augmented logging functions, thereby performing session-specific logging to capture log data corresponding to a session-specific log level during the session; and storing the log data.

In Example 2, the subject matter of Example 1 includes, wherein the one or more augmented logging functions add the session-specific logging to default logging associated with the one or more original logging functions, and the executing of the software application with the one or more augmented logging functions comprises: performing the default logging at a global log level associated with the one or more original logging functions in addition to performing the session-specific logging at the session-specific log level.

In Example 3, the subject matter of Example 2 includes, wherein the log data comprises first log data stored at a first storage location, the default logging is performed to capture second log data corresponding to the global log level, and the operations further comprise: storing the second log data at a second storage location that differs from the first storage location.

In Example 4, the subject matter of any of Examples 2-3 includes, wherein the session-specific log level is an increased log level relative to the global log level.

In Example 5, the subject matter of any of Examples 2-4 includes, wherein the session-specific log level is a TRACE log level, a DEBUG log level, or an INFO log level.

In Example 6, the subject matter of any of Examples 1-5 includes, wherein the adapting of the one or more original logging functions comprises dynamically replacing the one or more original logging functions with the one or more augmented logging functions at runtime, the one or more augmented logging functions maintaining behavior of the one or more original logging functions and adding additional behavior to enable the session-specific logging.

In Example 7, the subject matter of Example 6 includes, wherein the one or more original logging functions comprise a plurality of original logging functions, each of the plurality of original logging functions being associated with a logging call for a respective log level, and the operations comprise dynamically replacing each of the plurality of original logging functions.

In Example 8, the subject matter of any of Examples 1-7 includes, the operations comprising: in response to detecting that the session-specific logging is to be applied, instantiating a session-specific logging component to: provide the one or more augmented logging functions; and receive logging calls to capture the log data.

In Example 9, the subject matter of Example 8 includes, wherein the session-specific logging component intercepts the logging calls directed to an original logging component associated with the one or more original logging functions.

In Example 10, the subject matter of any of Examples 1-9 includes, the operations further comprising: automatically integrating the log data with performance profile data of the software application.

In Example 11, the subject matter of Example 10 includes, wherein the performance profile data provides a hierarchical view reflecting an execution stack.

In Example 12, the subject matter of any of Examples 1-11 includes, the operations further comprising: receiving, from a computing device, a request indicating that the session-specific logging is to be applied, wherein the detecting that the session-specific logging is to be applied is based on the request.

In Example 13, the subject matter of Example 12 includes, wherein the request comprises a parameter indicating that the request is to be run at the session-specific log level.

In Example 14, the subject matter of any of Examples 12-13 includes, wherein the request is received at a server and originates from a client device associated with a user of the software application.

Example 15 is a computer-implemented method performed by a computer system comprising a memory and at least one hardware processor, the computer-implemented method comprising: detecting that session-specific logging is to be applied for a session of a software application; in response to detecting that the session-specific logging is to be applied, enabling the session-specific logging by dynamically adapting one or more original logging functions of the software application to provide one or more augmented logging functions; executing the software application with the one or more augmented logging functions, thereby performing session-specific logging to capture log data corresponding to a session-specific log level during the session; and storing the log data.

In Example 16, the subject matter of Example 15 includes, wherein the one or more augmented logging functions add the session-specific logging to default logging associated with the one or more original logging functions, and the executing of the software application with the one or more augmented logging functions comprises: performing the default logging at a global log level associated with the one or more original logging functions in addition to performing the session-specific logging at the session-specific log level.

In Example 17, the subject matter of Example 16 includes, wherein the log data comprises first log data stored at a first storage location, the default logging is performed to capture second log data corresponding to the global log level, and the computer-implemented method further comprises: storing the second log data at a second storage location that differs from the first storage location.

Example 18 is one or more non-transitory computer-readable media storing computer-executable instructions that, when executed by a computing system, cause the computing system to perform operations comprising: detecting that session-specific logging is to be applied for a session of a software application; in response to detecting that the session-specific logging is to be applied, enabling the session-specific logging by dynamically adapting one or more original logging functions of the software application to provide one or more augmented logging functions; executing the software application with the one or more augmented logging functions, thereby performing session-specific logging to capture log data corresponding to a session-specific log level during the session; and storing the log data.

In Example 19, the subject matter of Example 18 includes, wherein the one or more augmented logging functions add the session-specific logging to default logging associated with the one or more original logging functions, and the executing of the software application with the one or more augmented logging functions comprises: performing the default logging at a global log level associated with the one or more original logging functions in addition to performing the session-specific logging at the session-specific log level.

In Example 20, the subject matter of Example 19 includes, wherein the log data comprises first log data stored at a first storage location, the default logging is performed to capture second log data corresponding to the global log level, and the operations further comprise: storing the second log data at a second storage location that differs from the first storage location.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20. Example 23 is a system to implement any of Examples 1-20.

Example 24 is a method to implement any of Examples 1-20.

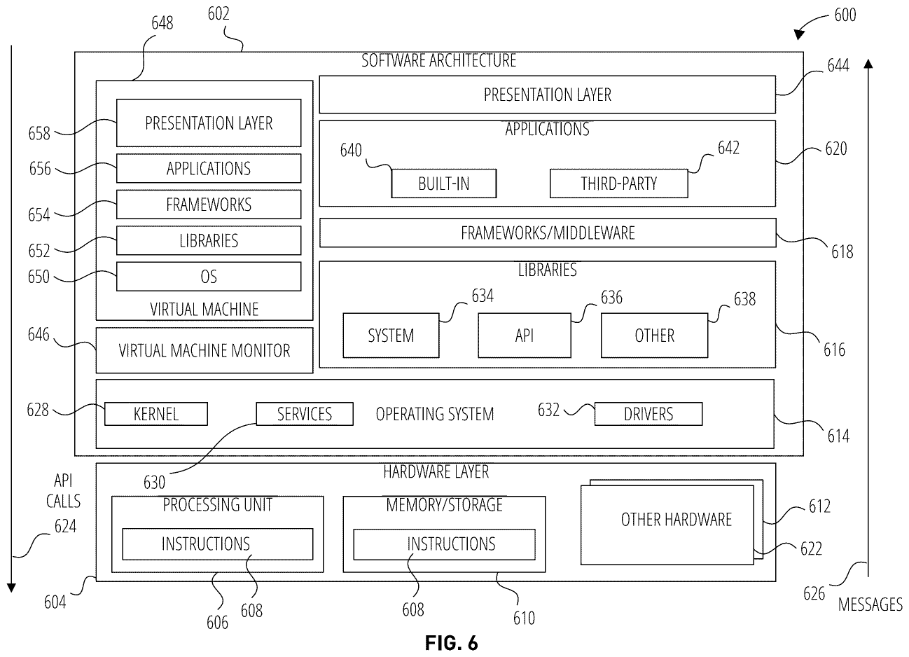

FIG. 6 is a block diagram 600 showing a software architecture 602 for a computing device, according to some examples. The software architecture 602 may be used in conjunction with various hardware architectures, for example, as described herein. FIG. 6 is merely a non-limiting illustration of a software architecture, and many other architectures may be implemented to facilitate the functionality described herein. A representative hardware layer 604 is illustrated and can represent, for example, any of the above referenced computing devices. In some examples, the hardware layer 604 may be implemented according to the architecture of the computer system of FIG. 7.

The representative hardware layer 604 comprises one or more processing units 606 having associated executable instructions 608. Executable instructions 608 represent the executable instructions of the software architecture 602, including implementation of the methods, modules, subsystems, and components, and so forth described herein and may also include memory and/or storage modules 610, which also have executable instructions 608. Hardware layer 604 may also comprise other hardware as indicated by other hardware 612 and other hardware 622 which represent any other hardware of the hardware layer 604, such as the other hardware illustrated as part of the software architecture 602.

In the architecture of FIG. 6, the software architecture 602 may be conceptualized as a stack of layers where each layer provides particular functionality. For example, the software architecture 602 may include layers such as an operating system 614, libraries 616, frameworks/middleware layer 618, applications 620, and presentation layer 644. Operationally, the applications 620 or other components within the layers may invoke API calls 624 through the software stack and access a response, returned values, and so forth illustrated as messages 626 in response to the API calls 624. The layers illustrated are representative in nature and not all software architectures have all layers. For example, some mobile or special purpose operating systems may not provide a frameworks/middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of an interrupt and, in response, cause the software architecture 602 to pause its current processing and execute an interrupt service routine (ISR) when an interrupt is accessed.

The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 616 may provide a common infrastructure that may be utilized by the applications 620 or other components or layers. The libraries 616 typically provide functionality that allows other software modules to perform tasks in an easier fashion than to interface directly with the underlying operating system 614 functionality (e.g., kernel 628, services 630 or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks/middleware layer 618 may provide a higher-level common infrastructure that may be utilized by the applications 620 or other software components/modules. For example, the frameworks/middleware layer 618 may provide various graphic user interface (GUI) functions, high-level resource management, high-level location services, and so forth. The frameworks/middleware layer 618 may provide a broad spectrum of other APIs that may be utilized by the applications 620 or other software components/modules, some of which may be specific to a particular operating system or platform.

The applications 620 include built-in applications 640 or third-party applications 642. Examples of representative built-in applications 640 may include, but are not limited to, a contacts application, a browser application, a book reader application, a location application, a media application, a messaging application, or a game application. Third-party applications 642 may include any of the built-in applications as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 642 may invoke the API calls 624 provided by the mobile operating system such as operating system 614 to facilitate functionality described herein.

The applications 620 may utilize built in operating system functions (e.g., kernel 628, services 630 or drivers 632), libraries (e.g., system libraries 634, API libraries 636, and other libraries 638), and frameworks/middleware layer 618 to create user interfaces to interact with users of the system. Alternatively, or additionally, in some systems, interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware computing device. A virtual machine is hosted by a host operating system (operating system 614) and typically, although not always, has a virtual machine monitor 646, which manages the operation of the virtual machine as well as the interface with the host operating system (e.g., operating system 614). A software architecture executes within the virtual machine 648 such as an operating system 650, libraries 652, frameworks/middleware 654, applications 656 or presentation layer 658. These layers of software architecture executing within the virtual machine 648 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines.

The one or more processors may also operate to support performance of the relevant operations in a “cloud computing” environment or as a “software as a service (Saas).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

FIG. 7 is a block diagram of a machine in the example form of a computer system 700 within which instructions 724 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a GPU, or both), a primary or main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a UI navigation (or cursor control) device 714 (e.g., a mouse), a storage unit 716, a signal generation device 718 (e.g., a speaker), and a network interface device 720.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

The storage unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 or within the processor 702 during execution thereof by the computer system 700, with the main memory 704 and the processor 702 also each constituting a machine-readable medium 722.

While the machine-readable medium 722 is shown in accordance with some examples to be a single medium, the term “machine-readable medium” may include a single medium or multiple media (e.g., a centralized or distributed database, or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of a machine-readable medium 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 724 may further be transmitted or received over a communications network 726 using a transmission medium. The instructions 724 may be transmitted using the network interface device 720 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 724 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors configured by the instructions to perform operations comprising:
detecting that session-specific logging is to be applied for a session of a software application;
in response to detecting that the session-specific logging is to be applied, enabling the session-specific logging by dynamically adapting one or more original logging functions of the software application to provide one or more augmented logging functions;
executing the software application with the one or more augmented logging functions, thereby performing session-specific logging to capture log data corresponding to a session-specific log level during the session; and
storing the log data.

2. The system of claim 1, wherein the one or more augmented logging functions add the session-specific logging to default logging associated with the one or more original logging functions, and the executing of the software application with the one or more augmented logging functions comprises:
performing the default logging at a global log level associated with the one or more original logging functions in addition to performing the session-specific logging at the session-specific log level.

3. The system of claim 2, wherein the log data comprises first log data stored at a first storage location, the default logging is performed to capture second log data corresponding to the global log level, and the operations further comprise:
storing the second log data at a second storage location that differs from the first storage location.

4. The system of claim 2, wherein the session-specific log level is an increased log level relative to the global log level.

5. The system of claim 2, wherein the session-specific log level is a TRACE log level, a DEBUG log level, or an INFO log level.

6. The system of claim 1, wherein the adapting of the one or more original logging functions comprises dynamically replacing the one or more original logging functions with the one or more augmented logging functions at runtime, the one or more augmented logging functions maintaining behavior of the one or more original logging functions and adding additional behavior to enable the session-specific logging.

7. The system of claim 6, wherein the one or more original logging functions comprise a plurality of original logging functions, each of the plurality of original logging functions being associated with a logging call for a respective log level, and the operations comprise dynamically replacing each of the plurality of original logging functions.

8. The system of claim 1, the operations comprising:
in response to detecting that the session-specific logging is to be applied, instantiating a session-specific logging component to:
provide the one or more augmented logging functions; and
receive logging calls to capture the log data.

9. The system of claim 8, wherein the session-specific logging component intercepts the logging calls directed to an original logging component associated with the one or more original logging functions.

10. The system of claim 1, the operations further comprising:
automatically integrating the log data with performance profile data of the software application.

11. The system of claim 10, wherein the performance profile data provides a hierarchical view reflecting an execution stack.

12. The system of claim 1, the operations further comprising:
receiving, from a computing device, a request indicating that the session-specific logging is to be applied, wherein the detecting that the session-specific logging is to be applied is based on the request.

13. The system of claim 12, wherein the request comprises a parameter indicating that the request is to be run at the session-specific log level.

14. The system of claim 12, wherein the request is received at a server and originates from a client device associated with a user of the software application.

15. A computer-implemented method performed by a computer system comprising a memory and at least one hardware processor, the computer-implemented method comprising:
detecting that session-specific logging is to be applied for a session of a software application;
in response to detecting that the session-specific logging is to be applied, enabling the session-specific logging by dynamically adapting one or more original logging functions of the software application to provide one or more augmented logging functions;
executing the software application with the one or more augmented logging functions, thereby performing session-specific logging to capture log data corresponding to a session-specific log level during the session; and
storing the log data.

16. The computer-implemented method of claim 15, wherein the one or more augmented logging functions add the session-specific logging to default logging associated with the one or more original logging functions, and the executing of the software application with the one or more augmented logging functions comprises:
performing the default logging at a global log level associated with the one or more original logging functions in addition to performing the session-specific logging at the session-specific log level.

17. The computer-implemented method of claim 16, wherein the log data comprises first log data stored at a first storage location, the default logging is performed to capture second log data corresponding to the global log level, and the computer-implemented method further comprises:
storing the second log data at a second storage location that differs from the first storage location.

18. One or more non-transitory computer-readable media storing computer-executable instructions that, when executed by a computing system, cause the computing system to perform operations comprising:
detecting that session-specific logging is to be applied for a session of a software application;
in response to detecting that the session-specific logging is to be applied, enabling the session-specific logging by dynamically adapting one or more original logging functions of the software application to provide one or more augmented logging functions;
executing the software application with the one or more augmented logging functions, thereby performing session-specific logging to capture log data corresponding to a session-specific log level during the session; and
storing the log data.

19. The one or more non-transitory computer-readable media of claim 18, wherein the one or more augmented logging functions add the session-specific logging to default logging associated with the one or more original logging functions, and the executing of the software application with the one or more augmented logging functions comprises:
performing the default logging at a global log level associated with the one or more original logging functions in addition to performing the session-specific logging at the session-specific log level.

20. The one or more non-transitory computer-readable media of claim 19, wherein the log data comprises first log data stored at a first storage location, the default logging is performed to capture second log data corresponding to the global log level, and the operations further comprise:
storing the second log data at a second storage location that differs from the first storage location.
